(19) United States
(12) Patent Application Publication
(10) Pub. No.: US 2019/0258318 A1
(43) Pub. Date: Aug. 22, 2019

(54) TERMINAL FOR CONTROLLING ELECTRONIC DEVICE AND PROCESSING METHOD THEREOF

(71) Applicant: HUAWEI TECHNOLOGIES CO., LTD., Shenzhen, Guangdong (CN)

(72) Inventors: Chao QIN, Beijing (CN); Wenmei GAO, Beijing (CN); Xin CHEN, Shenzhen (CN)

(21) Appl. No.: 16/313,983

(22) PCT Filed: Jun. 28, 2016
(86) PCT No.: PCT/CN2016/087505

§ 371 Date: Dec. 28, 2018

(51) Int. Cl. G06F 3/01; G10L 15/22

(52) U.S. Cl. CPC G06F 3/017; G10L 2015/223; G10L 15/22; G06F 3/012

(57) ABSTRACT

This application discloses a terminal for controlling an electronic device and a processing method thereof The terminal detects a direction of a finger or an arm to help determine an object for executing a voice instruction. When a user sends a voice instruction, the terminal can quickly and accurately determine an object for executing the voice instruction, without specifying a device for executing the command.

### TECHNICAL FIELD

The present invention relates to the communications field, and in particular, to a terminal for controlling an electronic device and a processing method thereof.

### BACKGROUND

With development of technologies, an electronic device has higher intelligence. Using a voice to control an electronic device is an important direction of development toward intelligence for the electronic device currently.

Currently, an implementation of performing voice control on the electronic device is generally based on speech recognition. The implementation is specifically as follows: The electronic device performs speech recognition on a voice generated by a user, and determines, according to a speech recognition result, a voice instruction that the user expects the electronic device to execute. Afterward, the electronic device automatically executes the voice instruction, and voice control on the electronic device is implemented.

However, when multiple electronic devices exist in an environment of the user, a similar or same voice instruction may be executed by multiple electronic devices. For example, when multiple intelligent appliances such as a smart television, a smart air conditioner, and a smart lamp exist in a house of the user, if a command of the user is not correctly recognized, an operation that is not anticipated by the user may be performed by another electronic device incorrectly. Therefore, how to quickly determine an object for executing a voice instruction is a technical problem that needs to be resolved urgently in the industry.

### SUMMARY

In view of the foregoing technical problem, objectives of the present invention are to provide a terminal for controlling an electronic device and a processing method thereof to detect a direction of a finger or an arm to help determine an object for executing a voice instruction. When a user sends a voice instruction, the terminal can quickly and accurately determine an object for executing the voice instruction, without specifying a device for executing the command. Therefore, an operation is more suitable for a user habit, and a response speed is higher.

According to a first aspect, a method is provided and applied to a terminal, where the method includes: receiving a voice instruction that is sent by a user and does not specify an execution object; recognizing a gesture action of the user, and determining, according to the gesture action, a target to which the user points, where the target includes an electronic device, an application program installed on an electronic device, or an operation option in a function interface of an application program installed on an electronic device; converting the voice instruction into an operation instruction, where the operation instruction can be executed by the electronic device; and sending the operation instruction to the electronic device. In the foregoing method, the object for executing the voice instruction may be determined according to the gesture action.

In a possible design, another voice instruction that is sent by the user and specifies an execution object is received; the another voice instruction is converted into another operation instruction that can be executed by the execution object; and the another operation instruction is sent to the execution object. When the execution object is specified in the voice instruction, the execution object may execute the voice instruction.

In a possible design, the recognizing a gesture action of the user, and determining, according to the gesture action, a target to which the user points includes: recognizing an action of stretching out a finger by the user, obtaining a location of a dominant eye of the user in three-dimensional space and a location of a tip of the finger in the three-dimensional space, and determining a target to which a straight line connecting the dominant eye to the tip points in the three-dimensional space. The target to which the user points may be determined accurately according to the straight line connecting the dominant eye of the user to the tip of the finger.

In a possible design, the recognizing a gesture action of the user, and determining, according to the gesture action, a target to which the user points includes: recognizing an action of raising an arm by the user, and determining a target to which an extension line of the arm points in the three-dimensional space. The target to which the user points may be determined conveniently according to the extension line of the arm.

In a possible design, the straight line points to at least one electronic device in the three-dimensional space, and the determining a target to which a straight line connecting the dominant eye to the tip points in the three-dimensional space includes: prompting the user to select one of the at least one electronic device. When multiple electronic devices exist in a pointed-to direction, the user may select one of the electronic devices to execute the voice instruction.

In a possible design, the extension line points to at least one electronic device in the three-dimensional space, and the determining a target to which an extension line of the arm points in the three-dimensional space includes: prompting the user to select one of the at least one electronic device. When multiple electronic devices exist in a pointed-to direction, the user may select one of the electronic devices to execute the voice instruction.

In a possible design, the terminal is a head-mounted display device, and the target to which the user points is highlighted in the head-mounted display device. The head-mounted device may be used to prompt, in an augmented reality mode, the target to which the user points, and there is a better prompt effect.

In a possible design, the voice instruction is used for payment, and before the operation instruction is sent to the electronic device, whether a biological feature of the user matches a registered biological feature of the user is detected. Therefore, payment security may be provided.

According to a second aspect, a method is provided and applied to a terminal, where the method includes: receiving a voice instruction that is sent by a user and does not specify an execution object; recognizing a gesture action of the user, and determining, according to the gesture action, an electronic device to which the user points, where the electronic device cannot respond to the voice instruction; converting the voice instruction into an operation instruction, where the operation instruction can be executed by the electronic device; and sending the operation instruction to the electronic device. In the foregoing method, the electronic device for executing the voice instruction may be determined according to the gesture action.

In a possible design, another voice instruction that is sent by the user and specifies an execution object is received, where the execution object is an electronic device; the another voice instruction is converted into another operation instruction that can be executed by the execution object; and the another operation instruction is sent to the execution object. When the execution object is specified in the voice instruction, the execution object may execute the voice instruction.

In a possible design, the recognizing a gesture action of the user, and determining, according to the gesture action, an electronic device to which the user points includes: recognizing an action of stretching out a finger by the user, obtaining a location of a dominant eye of the user in three-dimensional space and a location of a tip of the finger in the three-dimensional space, and determining an electronic device to which a straight line connecting the dominant eye to the tip points in the three-dimensional space. The electronic device to which the user points may be determined accurately according to the straight line connecting the dominant eye of the user to the tip of the finger.

In a possible design, the recognizing a gesture action of the user, and determining, according to the gesture action, an electronic device to which the user points includes: recognizing an action of raising an arm by the user, and determining an electronic device to which an extension line of the arm points in the three-dimensional space. The electronic device to which the user points may be determined conveniently according to the extension line of the arm.

In a possible design, the straight line points to at least one electronic device in the three-dimensional space, and the determining an electronic device to which a straight line connecting the dominant eye to the tip points in the three-dimensional space includes: prompting the user to select one of the at least one electronic device. When multiple electronic devices exist in a pointed-to direction, the user may select one of the electronic devices to execute the voice instruction.

In a possible design, the extension line points to at least one electronic device in the three-dimensional space, and the determining an electronic device to which an extension line of the arm points in the three-dimensional space includes: prompting the user to select one of the at least one electronic device. When multiple electronic devices exist in a pointed-to direction, the user may select one of the electronic devices to execute the voice instruction.

In a possible design, the terminal is a head-mounted display device, and the target to which the user points is highlighted in the head-mounted display device. The head-mounted device may be used to prompt, in an augmented reality mode, the target to which the user points, and there is a better prompt effect.

In a possible design, the voice instruction is used for payment, and before the operation instruction is sent to the electronic device, whether a biological feature of the user matches a registered biological feature of the user is detected. Therefore, payment security may be provided.

According to a third aspect, a method is provided and applied to a terminal, where the method includes: receiving a voice instruction that is sent by a user and does not specify an execution object; recognizing a gesture action of the user, and determining, according to the gesture action, an object to which the user points, where the object includes an application program installed on an electronic device or an operation option in a function interface of an application program installed on an electronic device, and the electronic device cannot respond to the voice instruction; converting the voice instruction into an object instruction, where the object instruction includes an instruction used to identify the object, and the object instruction can be executed by the electronic device; and sending the object instruction to the electronic device. In the foregoing method, the application program or the operation option that the user expects to control may be determined according to the gesture action.

In a possible design, another voice instruction that is sent by the user and specifies an execution object is received; the another voice instruction is converted into another object instruction; and the another object instruction is sent to an electronic device in which the specified execution object is located. When the execution object is specified in the voice instruction, the electronic device in which the execution object is located may execute the voice instruction.

In a possible design, the recognizing a gesture action of the user, and determining, according to the gesture action, an object to which the user points includes: recognizing an action of stretching out a finger by the user, obtaining a location of a dominant eye of the user in three-dimensional space and a location of a tip of the finger in the three-dimensional space, and determining an object to which a straight line connecting the dominant eye to the tip points in the three-dimensional space. The object to which the user points may be determined accurately according to the straight line connecting the dominant eye of the user to the tip of the finger.

In a possible design, the recognizing a gesture action of the user, and determining, according to the gesture action, an object to which the user points includes: recognizing an action of raising an arm by the user, and determining an object to which an extension line of the arm points in the three-dimensional space. The object to which the user points may be determined conveniently according to the extension line of the arm.

In a possible design, the terminal is a head-mounted display device, and the target to which the user points is highlighted in the head-mounted display device. The head-mounted device may be used to prompt, in an augmented reality mode, the object to which the user points, and there is a better prompt effect.

In a possible design, the voice instruction is used for payment, and before the operation instruction is sent to the electronic device, whether a biological feature of the user matches a registered biological feature of the user is detected. Therefore, payment security may be provided.

According to a fourth aspect, a terminal is provided, where the terminal includes units configured to perform the method according to any one of the first to the third aspects or possible implementations of the first to the third aspects.

According to a fifth aspect, a computer readable storage medium storing one or more programs is provided, where the one or more programs include an instruction, and when the instruction is executed by a terminal, the terminal performs the method according to any one of the first to the third aspects or possible implementations of the first to the third aspects.

According to a sixth aspect, a terminal is provided, where the terminal may include one or more processors, a memory, a display, a bus system, a transceiver, and one or more programs, where the processor, the memory, the display, and the transceiver are connected by the bus system, where
the one or more programs are stored in the memory, the one or more programs include an instruction, and when the instruction is executed by the terminal, the terminal performs the method according to any one of the first to the third aspects or possible implementations of the first to the third aspects.

According to a seventh aspect, a graphical user interface on a terminal is provided, where the terminal includes a memory, multiple application programs, and one or more processors configured to execute one or more programs stored in the memory, and the graphical user interface includes a user interface displayed in the method according to any one of the first to the third aspects or possible implementations of the first to the third aspects.

Optionally, the following possible designs may be combined with the first aspect to the seventh aspect of the present invention.

In a possible design, the terminal is a controlling device suspended or placed in the three-dimensional space. This may mitigate burden of wearing the head-mounted display device by the user.

In a possible design, the user selects one of multiple electronic devices by bending a finger or stretching out different quantities of fingers. A further gesture action of the user is recognized, and therefore, which one of multiple electronic devices on a same straight line or extension line is a target to which the user points may be determined.

According to the foregoing technical solutions, an object for executing a voice instruction of a user can be determined quickly and accurately. When the user sends a voice instruction, a device that specifically executes the command does not need to be specified. In comparison with a conventional voice instruction, this may reduce a response time by more than a half.

### BRIEF DESCRIPTION OF DRAWINGS

FIG. 1 is a schematic diagram of a possible application scenario according to the present invention;

FIG. 2 is a schematic structural diagram of a perspective display system according to the present invention;

FIG. 3 is a block diagram of a perspective display system according to the present invention;

FIG. 4 is a flowchart of a method for controlling an electronic device by a terminal according to the present invention;

FIG. 5 is a flowchart of a method for determining a dominant eye according to an embodiment of the present invention;

FIG. 6(a) and FIG. 6(b) are schematic diagrams for determining an object for executing a voice instruction according to a first gesture action according to an embodiment of the present invention;

FIG. 6(c) is a schematic diagram of a first angle-of-view image seen by a user when an execution object is determined according to a first gesture action;

FIG. 7(a) is a schematic diagram for determining an object for executing a voice instruction according to a second gesture action according to an embodiment of the present invention;

FIG. 7(b) is a schematic diagram of a first angle-of-view image seen by a user when an execution object is determined according to a second gesture action;

FIG. 8 is a schematic diagram for controlling multiple applications on an electronic device according to an embodiment of the present invention; and

FIG. 9 is a schematic diagram for controlling multiple electronic devices on a same straight line according to an embodiment of the present invention.

### DESCRIPTION OF EMBODIMENTS

The following clearly and completely describes the technical solutions in the embodiments of the present invention with reference to the accompanying drawings in the embodiments of the present invention. Apparently, the described embodiments are merely some but not all of the embodiments of the present invention. The following descriptions are merely examples of embodiments of the present invention, but are not intended to limit the present invention. Any modification, equivalent replacement, or improvement made without departing from the spirit and principle of the present invention shall fall within the protection scope of the present invention.

It should be understood that, ordinal numbers such as “first” and “second”, when mentioned in the embodiments of the present invention, are used only for distinguishing, unless the ordinal numbers definitely represent an order according to the context.

An “electronic device” described in the present invention may be a communicable device placed everywhere indoors, and includes an appliance that executes a preset function and an additional function. For example, the appliance includes lighting equipment, a television, an air conditioner, an electric fan, a refrigerator, a socket, a washing machine, an automatic curtain, a security monitoring device, or the like. The “electronic device” may also be a portable communications device that includes functions of a personal digital assistant (PDA) and/or a portable multimedia player (PMP), such as a notebook computer, a tablet computer, a smartphone, or an in-vehicle display. In the present invention, the “electronic device” may also be referred to as “an intelligent device” or “an intelligent electronic device”.

A perspective display system, for example, a head-mounted display (HMD, Head-Mounted Display) or another near-eye display device, may be configured to present an augmented reality (AR, Augmented Reality) view of a background scene to a user. Such an augmented reality environment may include various virtual objects and real objects that the user may interact with by using a user input (for example, a voice input, a gesture input, an eye trace input, a motion input, and/or any other appropriate input type). In a more specific example, the user may execute, by using a voice input, a command associated with a selected object in the augmented reality environment.

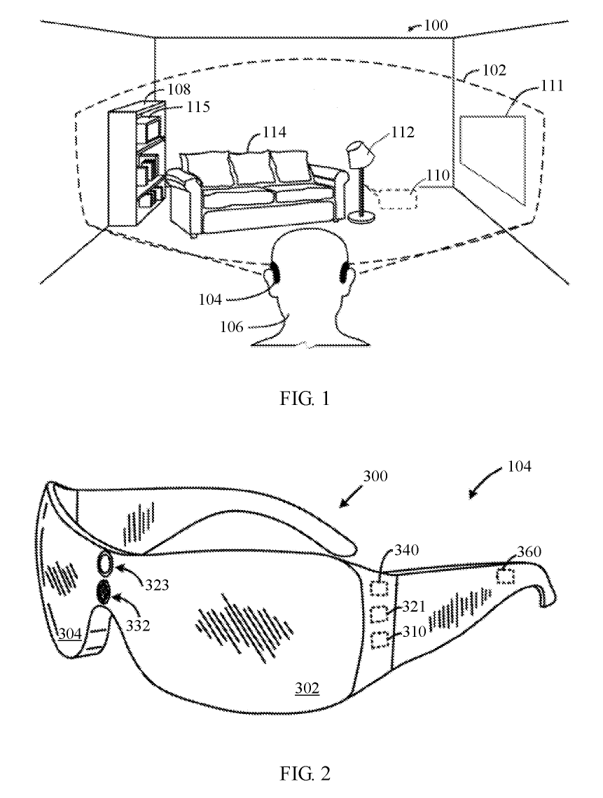

FIG. 1 shows an example of an embodiment of an environment in which a head-mounted display device 104 (HMD 104) is used. The environment 100 is in a form of a living room. A user is viewing the living room by using an augmented reality computing device in a form of a perspective HMD 104, and may interact with the augmented environment by using a user interface of the HMD 104. FIG. 1 further depicts a field of view 102 of the user, including a part of the environment that may be seen by using the HMD 104, and therefore, the part of the environment may be augmented by using an image displayed by the HMD 104. The augmented environment may include multiple display objects. For example, a display object is an intelligent device that the user may interact with. In the embodiment shown in FIG. 1, the display objects in the augmented environment include a television device 111, lighting equipment 112, and a media player device 115. Each of the objects in the augmented environment may be selected by the user 106, so that the user 106 can perform an action on the selected object. In addition to the foregoing multiple real display objects, the augmented environment may include multiple virtual objects, for example, a device label 110 that is described in detail hereinafter. In some embodiments, a range of the field of view 102 of the user may be in essence the same as that of an actual field of view of the user. However, in other embodiments, the field of view 102 of the user may be narrower than the actual field of view of the user.

The HMD 104, as described in more detail hereinafter, may include one or more outward image sensors (for example, an RGB camera and/or a depth camera). When the user browses the environment, the HMD 104 is configured to obtain image data (for example, a color/gray image, a depth image or a point cloud image, or the like) indicating the environment 100. The image data may be used to obtain information about an environment layout (for example, a three-dimensional surface diagram) and objects (for example, a bookcase 108, a sofa 114, and the media player device 115) included in the environment layout. The one or more outward image sensors are further configured to position a finger and an arm of the user.

The HMD 104 may cover a real object in the field of view 102 of the user with one or more virtual images or objects. An example of a virtual object depicted in FIG. 1 includes the device label 110 displayed near the lighting equipment 112. The device label 110 is used to indicate a device type that is recognized successfully, and is used to prompt the user that the device is already recognized successfully. In this embodiment, content displayed by the device label 110 may be “smart lamp”. The virtual images or objects may be displayed in three dimensions, so that the images or objects in the field of view 102 of the user seem to be in different depths for the user 106. The virtual objects displayed by the HMD 104 may be visible only to the user 106, and may move when the user 106 moves, or may be always in specified positions regardless of how the user 106 moves.

A user (for example, the user 106) of an augmented reality user interface can perform any appropriate action on a real object and a virtual object in the augmented reality environment. The user 106 can select, in any appropriate manner that can be detected by the HMD 104, an object for interaction, for example, send one or more voice instructions that may be detected by a microphone. The user 106 may further select an interaction object by using a gesture input or a motion input.

In some examples, the user may select only a single object in the augmented reality environment to perform an action on the object. In some examples, the user may select multiple objects in the augmented reality environment to perform an action on each of the multiple objects. For example, when the user 106 sends a voice instruction “reduce volume”, the media player device 115 and the television device 111 may be selected to execute a command to reduce volume of the two devices.

Before multiple objects are selected to perform actions simultaneously, whether a voice instruction sent by the user is directed to a specific object should be first recognized. Details about the recognition method are described in detail in subsequent embodiments.

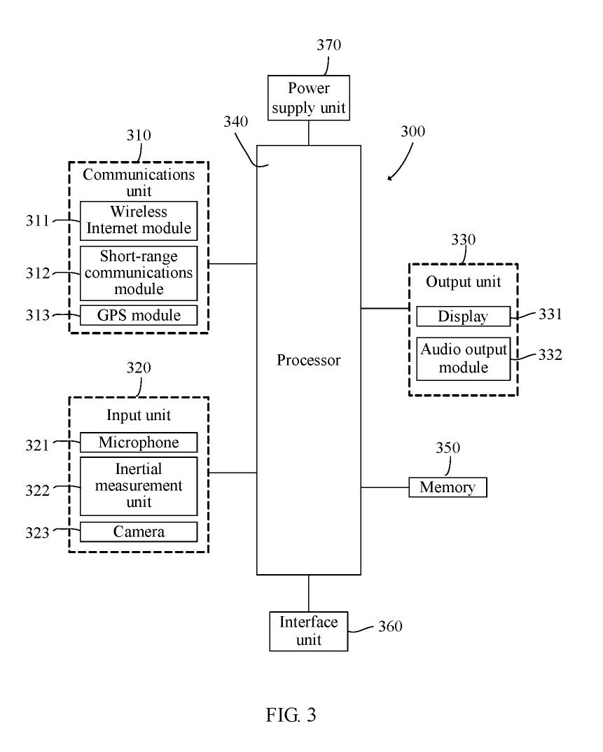

The perspective display system disclosed according to the present invention may use any appropriate form, including but not limited to a near-eye device such as the head-mounted display device 104 in FIG. 1. For example, the perspective display system may also be a single-eye device, or has a head-mounted helmet structure. The following discusses more details about a perspective display system 300 with reference to FIG. 2 and FIG. 3.

FIG. 2 shows an example of a perspective display system 300, and FIG. 3 shows a block diagram of a display system 300.

As shown in FIG. 3, the perspective display system 300 includes a communications unit 310, an input unit 320, an output unit 330, a processor 340, a memory 350, an interface unit 360, a power supply unit 370, and the like. FIG. 3 shows the perspective display system 300 having various components. However, it should be understood that, an implementation of the perspective display system 300 does not necessarily require all the components shown in the figure. The perspective display system 300 may be implemented by using more or fewer components.

The following explains each of the foregoing components.

The communications unit 310 generally includes one or more components. The component allows wireless communication between the perspective display system 300 and multiple display objects in an augmented environment, so as to transmit commands and data. The component may also allow communication between multiple perspective display systems 300, and wireless communication between the perspective display system 300 and a wireless communications system. For example, the communications unit 310 may include at least one of a wireless Internet module 311 or a short-range communications module 312.

The wireless Internet module 311 provides support for wireless Internet access for the perspective display system 300. Herein, as a wireless Internet technology, a wireless local area network (WLAN), Wi-Fi, wireless broadband (WiBro), Worldwide Interoperability for Microwave Access (WiMax), High Speed Downlink Packet Access (HSDPA), or the like may be used.

The short-range communications module 312 is a module configured to support short-range communication. Examples of short-range communications technologies may include Bluetooth (Bluetooth), radio frequency identification (RFID), the Infrared Data Association (IrDA), ultra-wideband (UWB), ZigBee (ZigBee), D2D (Device-to-Device), and the like.

The communications unit 310 may further include a GPS (global positioning system) module 313. The GPS module receives radio waves from multiple GPS satellites (not shown) on the earth's orbit, and may compute a location of the perspective display system 300 by using an arrival time of the radio waves from the GPS satellites at the perspective display system 300.

The input unit 320 is configured to receive an audio or video signal. The input unit 320 may include a microphone 321, an inertial measurement unit (IMU) 322, and a camera 323.

The microphone 321 may receive a sound corresponding to a voice instruction of a user 106 and/or an ambient sound generated in an environment of the perspective display system 300, and process a received sound signal into electrical voice data. The microphone may use any one of various denoising algorithms to remove noise generated when an external sound signal is received.

The inertial measurement unit (IMU) 322 is configured to sense a location, a direction, and an acceleration (pitching, rolling, and yawing) of the perspective display system 300, and determine a relative position relationship between the perspective display system 300 and a display object in the augmented environment through computation. When the user 106 wearing the perspective display system 300 uses the system for the first time, the user may input parameters related to an eye of the user, for example, an interpupillary distance and a pupil diameter. After x, y, and z of the location of the perspective display system 300 in the environment 100 are determined, a location of the eye of the user 106 wearing the perspective display system 300 may be determined through computation. The inertial measurement unit 322 (or IMU 322) includes an inertial sensor, such as a tri-axis magnetometer, a tri-axis gyroscope, or a tri-axis accelerometer.

The camera 323 processes, in a video capture mode or an image capture mode, image data of a video or a still image obtained by an image capture apparatus, and further obtains image information of a background scene and/or physical space viewed by the user. The image information of the background scene and/or the physical space includes the foregoing multiple display objects that may interact with the user. The camera 323 optionally includes a depth camera and an RGB camera (also referred to as a color camera).

The depth camera is configured to capture a depth image information sequence of the background scene and/or the physical space, and construct a three-dimensional model of the background scene and/or the physical space. The depth camera is further configured to capture a depth image information sequence of an arm or a finger of the user, and determine locations of the arm and the finger of the user in the background scene and/or the physical space and distances from the arm and the finger to the display objects. The depth image information may be obtained by using any appropriate technology, including but not limited to a time of flight, structured light, and a three-dimensional image. Depending on a technology used in depth sensing, the depth camera may require additional components (for example, an infrared emitter needs to be disposed when the depth camera detects an infrared structured light pattern), although the additional components may not be in a same position as the depth camera.

The RGB camera (also referred to as a color camera) is configured to capture the image information sequence of the background scene and/or the physical space at a visible light frequency, and the RGB camera is further configured to capture the image information sequence of the arm and the finger of the user at a visible light frequency.

According to configurations of the perspective display system 300, two or more depth cameras and/or RGB cameras may be provided. The RGB camera may use a fisheye lens with a wide field of view.

The output unit 330 is configured to provide an output (for example, an audio signal, a video signal, an alarm signal, or a vibration signal) in a visual, audible, and/or tactile manner. The output unit 330 may include a display 331 and an audio output module 332.

As shown in FIG. 2, the display 331 includes lenses 302 and 304, so that an augmented environment image may be displayed through the lenses 302 and 304 (for example, through projection on the lens 302, through a waveguide system included in the lens 302, and/or in any other appropriate manner). Either of the lenses 302 and 304 may be fully transparent to allow the user to perform viewing through the lens. When an image is displayed in a projection manner, the display 331 may further include a micro projector 333 not shown in FIG. 2. The micro projector 333 is used as an input light source of an optical waveguide lens and provides a light source for displaying content. The display 331 outputs an image signal related to a function performed by the perspective display system 300. For example, an object is recognized correctly, and the finger has selected an object, as described in detail hereinafter.

The audio output module 332 outputs audio data that is received from the communications unit 310 or stored in the memory 350. In addition, the audio output module 332 outputs a sound signal related to a function performed by the perspective display system 300, for example, a voice instruction receiving sound or a notification sound. The audio output module 332 may include a speaker, a receiver, or a buzzer.

The processor 340 may control overall operations of the perspective display system 300, and perform control and processing associated with augmented reality displaying, voice interaction, and the like. The processor 340 may receive and interpret an input from the input unit 320, perform speech recognition processing, compare a voice instruction received through the microphone 321 with a voice instruction stored in the memory 350, and determine an object for executing the voice instruction. When no execution object is specified in the voice instruction, the processor 340 can further determine, based on an action and a location of the finger or the arm of the user, an object that is expected by the user to execute the voice instruction. After the object for executing the voice instruction is determined, the processor 340 may further execute an action or a command or another task or the like on the selected object.

A determining unit that is disposed separately or is included in the processor 340 may be used to determine, according to a gesture action received by the input unit, a target to which the user points.

A conversion unit that is disposed separately or is included in the processor 340 may be used to convert the voice instruction received by the input unit into an operation instruction that can be executed by an electronic device.

An instructing unit that is disposed separately or is included in the processor 340 may be used to instruct the user to select one of multiple electronic devices.

A detection unit that is disposed separately or is included in the processor 340 may be used to detect a biological feature of the user.

The memory 350 may store a software program executed by the processor 340 to process and control operations, and may store input or output data, for example, meanings of user gestures, voice instructions, a result of determining a direction to which the finger points, information about the display objects in the augmented environment, and a three-dimensional model of the background scene and/or the physical space. In addition, the memory 350 may further store data related to an output signal of the output unit 330.

An appropriate storage medium of any type may be used to implement the memory. The storage medium includes a flash memory, a hard disk, a micro multimedia card, a memory card (for example, an SD memory or a DX memory), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disc, or the like. In addition, the head-mounted display device 104 may perform operations related to a network storage apparatus that performs a storage function of a memory on the Internet.

The interface unit 360 may be generally implemented to connect the perspective display system 300 to an external device. The interface unit 360 may allow receiving data from the external device, and transmit electric power to each component of the perspective display system 300, or transmit data from the perspective display system 300 to the external device. For example, the interface unit 360 may include a wired/wireless headphone port, an external charger port, a wired/wireless data port, a memory card port, an audio input/output (I/O) port, a video I/O port, or the like.

The power supply unit 370 is configured to supply electric power to each component of the head-mounted display device 104, so that the head-mounted display device 104 can perform an operation. The power supply unit 370 may include a charge battery, a cable, or a cable port. The power supply unit 370 may be disposed in each position on a framework of the head-mounted display device 104.

Each implementation described in the specification may be implemented in a computer readable medium or another similar medium by using software, hardware, or any combination thereof

For a hardware implementation, the embodiment described herein may be implemented by using at least one of an application-specific integrated circuit (ASIC), a digital signal processor (DSP), a digital signal processing device (DSPD), a programmable logic device (PLD), a field programmable gate array (FPGA), a central processing unit (CPU), a general purpose processor, a microprocessor, or an electronic unit that is designed to perform the functions described herein. In some cases, this embodiment may be implemented by the processor 340 itself

For a software implementation, an embodiment of a program or a function or the like described herein may be implemented by a separate software module. Each software module may perform one or more functions or operations described herein.

A software application compiled in any appropriate programming language can implement software code. The software code may be stored in the memory 350 and executed by the processor 340.

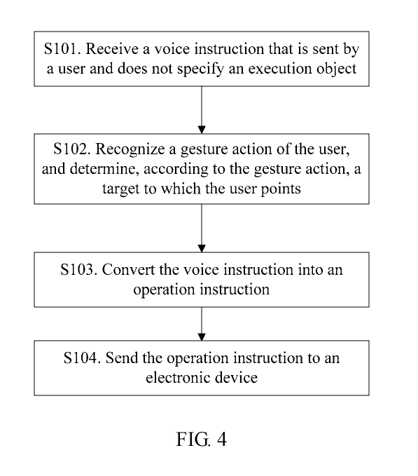

FIG. 4 is a flowchart of a method for controlling an electronic device by a terminal according to the present invention.

In step S101, a voice instruction that is sent by a user and does not specify an execution object is received, where the voice instruction that does not specify the execution object may be “power on”, “power off”, “pause”, “increase volume”, or the like.

In step S102, a gesture action of the user is recognized, and a target to which the user points is determined according to the gesture action, where the target includes an electronic device, an application program installed on an electronic device, or an operation option in a function interface of an application program installed on an electronic device.

The electronic device cannot directly respond to the voice instruction that does not specify the execution object, or the electronic device requires further confirmation before responding to the voice instruction that does not specify the execution object.

A specific method for determining the pointed-to target according to the gesture action is discussed in detail later.

Step S101 and step S102 may be interchanged, that is, the gesture action of the user is first recognized, and then the voice instruction that is sent by the user and does not specify the execution object is received.

In step S103, the voice instruction is converted into an operation instruction, where the operation instruction can be executed by the electronic device.

The electronic device may be a non voice control device. A terminal controlling the electronic device converts the voice instruction into a format that the non voice control device can recognize and execute. The electronic device may be a voice control device. The terminal controlling the electronic device may wake the electronic device by sending a wakeup instruction, and then send the received voice instruction to the electronic device.

When the electronic device is a voice control device, the terminal controlling the electronic device may further convert the received voice instruction into an operation instruction carrying information about the execution object.

In step S104, the operation instruction is sent to the electronic device.

Optionally, the following steps S105 and S106 may be combined with the foregoing steps S101 to S104.

In step S105, another voice instruction that is sent by the user and specifies an execution object is received.

In step S106, the another voice instruction is converted into another operation instruction that can be executed by the execution object.

In step S107, the another operation instruction is sent to the execution object.

When the execution object is specified in the voice instruction, the voice instruction may be converted into an operation instruction that the execution object can execute, so that the execution object executes the voice instruction.

Optionally, the following aspect may be combined with the foregoing steps S101 to S104.

Optionally, a first gesture action of the user is recognized, and a target to which the user points is determined according to the gesture action. This includes: recognizing an action of stretching out a finger by the user, obtaining a location of a dominant eye of the user in three-dimensional space and a location of a tip of the finger in the three-dimensional space, and determining a target to which a straight line connecting the dominant eye to the tip points in the three-dimensional space.

Optionally, a second gesture action of the user is recognized, and a target to which the user points is determined according to the gesture action. This includes: recognizing an action of raising an arm by the user, and determining a target to which an extension line of the arm points in the three-dimensional space.

The following uses an HMD 104 as an example to describe a method for controlling an electronic device by a terminal.

With reference to accompanying drawings of the present invention, more details about detecting a voice instruction and a gesture action that are input by an input unit 320 of the HMD 104 are discussed.

Before describing in detail how to detect a voice instruction and determine an object for executing the voice instruction, the following first describes some basic operations in a perspective display system.

When a user 106 wearing the HMD 104 looks around, three-dimensional modeling is performed on an environment 100 in which the HMD 104 is used, and a location of each intelligent device in the environment 100 is obtained. Specifically, the location of the intelligent device may be obtained by using a conventional simultaneous localization and mapping (English full name: Simultaneous localization and mapping, SLAM) technology, and another technology well known to a person skilled in the art. The SLAM technology may allow the HMD 104 to depart from an unknown place of an unknown environment, determine a location and a posture of the HMD 104 by using features (for example, a corner of a wall and a pillar) of a map that are observed repeatedly in a moving process, and incrementally create the map according to the location of the HMD 104, thereby achieving an objective of simultaneous localization and mapping. It is known that Microsoft Kinect Fusion and Google

Project Tango use the SLAM technology, and that both use similar procedures. In the present invention, image data (for example, a color/gray image or a depth image or a point cloud image) is obtained by using the foregoing depth camera and RGB camera, and a moving track of the HMD 104 is obtained with help of an inertial measurement unit 322; relative positions of multiple display objects (intelligent devices) that may interact with the user in a background scene and/or physical space, and relative positions of the HMD 104 and the display objects may be obtained through computation; and then learning and modeling are performed on three-dimensional space, and a model of the three-dimensional space is generated. In addition to constructing the three-dimensional model of the background scene and/or the physical space of the user, in the present invention, a type of an intelligent device in the background scene and/or the physical space is also determined by using various image recognition technologies well known to a person skilled in the art. As described above, after the type of the intelligent device is recognized successfully, the HMD 104 may display a corresponding device label 110 in a field of view 102 of the user, and the device label 110 is used to prompt the user that the device is already recognized successfully.

In some embodiments of the present invention hereinafter, a location of an eye of the user needs to be determined, and the location of the eye is used to help determine an object that is expected by the user to execute the voice instruction. Determining a dominant eye helps the HMD 104 adapt to features and operation habits of different users, so that a result of determining a direction to which a user points is more accurate. The dominant eye is also referred to as a fixating eye or a preferential eye. From a perspective of human physiology, each person has a dominant eye. The dominant eye may be a left eye or a right eye. Things seen by the dominant eye are accepted by a brain preferentially.

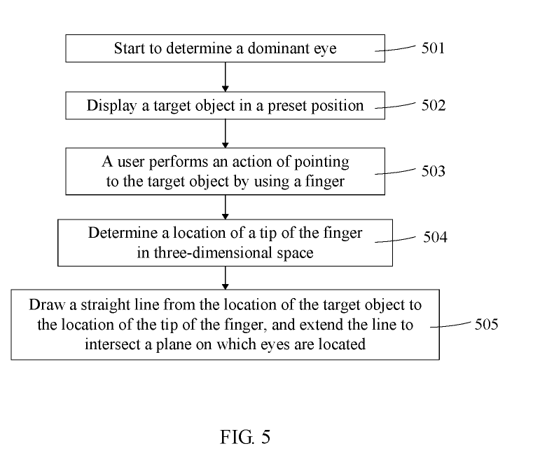

With reference to FIG. 5, the following discusses a method for determining a dominant eye.

As shown in FIG. 5, before step 501 of starting to determine a dominant eye, the foregoing three-dimensional modeling action needs to be implemented on an environment 100 first. Then, in step 502, a target object is displayed in a preset position, where the target object may be displayed on a display device connected to an HMD 104, or may be displayed in an AR manner on a display 331 of an HMD 104. Next, in step 503, the HMD 104 may prompt, in a voice manner or a text/graphical manner on the display 331, a user to perform an action of pointing to the target object by using a finger, where the action is consistent with the user's action of pointing to an object for executing a voice instruction, and the finger of the user points to the target object naturally. Then, in step 504, an action of stretching an arm together with the finger by the user is detected, and a location of a tip of the finger in three-dimensional space is determined by using the foregoing camera 323. The user may also not perform the action of stretching the arm together with the finger in step 504, provided that the finger already points to the target object as seen from the user. For example, the user may bend the arm toward the body, so that the tip of the finger and the target object are on a same straight line. Finally, in step 505, a straight line is drawn from the location of the target object to the location of the tip of the finger and is extended reversely, so that the straight line intersects a plane on which the eye is located, where an intersection point is a location of the dominant eye. In subsequent gesture positioning, the location of the dominant eye is used as the location of the eye. The intersection point may coincide with an eye of the user, or may coincide with neither of eyes of the user. When the intersection point does not coincide with the eye, the intersection point is used as an equivalent location of the eye, so as to comply with a pointing habit of the user.

The procedure for determining a dominant eye may be performed only once for a same user, because a dominant eye of a person is generally invariable. The HMD 104 may distinguish different users by using a biological feature authentication mode, and store data of dominant eyes of different users in the foregoing memory 350. The biological feature includes but is not limited to an iris, a voice print, or the like.

When the user 106 uses the HMD 104 for the first time, the user may further input, according to a system prompt, parameters related to an eye of the user, for example, an interpupillary distance and a pupil diameter. The related parameters may also be stored in the memory 350. The HMD 104 recognizes different users by using the biological feature authentication mode, and creates a user profile for each user. The user profile includes the data of the dominant eye, and the parameters related to the eye. When the user uses the HMD 104 again, the HMD 104 may directly invoke the user profile stored in the memory 350. There is no need to perform an input repeatedly and determine the dominant eye again.

When a person determines a target, pointing by a hand is a quickest and most visual means, and complies with an operation habit of a user. When the person determines the target that is pointed to, from a perspective of the person, an extension line from an eye to a tip of a finger is determined as a pointed-to direction. In some cases, for example, when a location of a target is very clear and attention is paid to other things currently, some persons may also stretch an arm, and a straight line formed by the arm is used as a pointed-to direction.

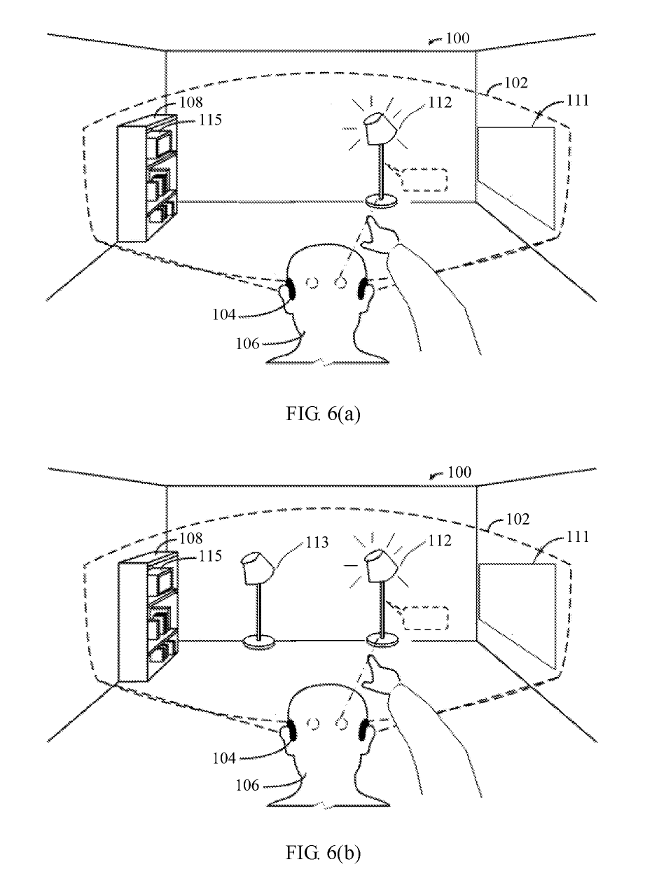

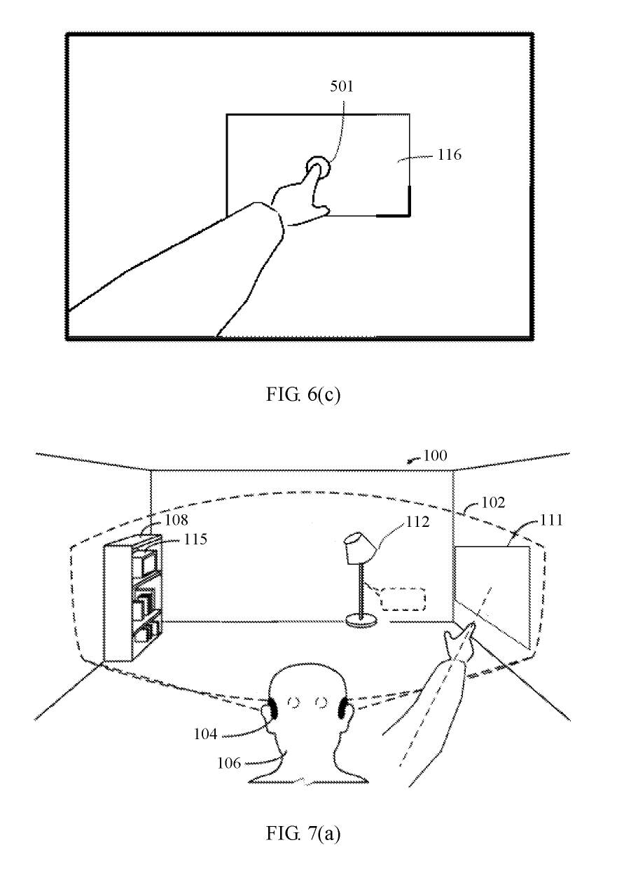

With reference to a first embodiment shown in FIG. 6(a) to FIG. 6(c), the following describes in detail a method for determining an object for executing a voice instruction according to a first gesture action, so as to control an intelligent device.

A processor 340 performs speech recognition processing, compares a voice instruction received through a microphone 321 with a voice instruction stored in a memory 350, and determines an object for executing the voice instruction. When no execution object is specified in the voice instruction, for example, the voice instruction is “power on”, the processor 304 determines, based on a first gesture action of a user 106, an object that is expected by the user 106 to execute the voice instruction “power on”. The first gesture action is a combined action of raising an arm, stretching out a forefinger to point to the front, and stretching out toward the pointed-to direction.

After the processor 340 detects that the user performs the first gesture action, first, a current spatial location of an eye of the user 106 is determined, and a location of a dominant eye of the user is used as a first reference point. Then, a current location of a tip of the forefinger in three-dimensional space is determined by using the foregoing camera 323, and the location of the tip of the forefinger of the user is used as a second reference point. Next, a radial is drawn from the first reference point to the second reference point, and an intersection point between the radial and an object in the space is determined. As shown in FIG. 6(a), the radial intersects lighting equipment 112, and the lighting equipment 112 is used as a device for executing the voice instruction “power on”. The voice instruction is converted into a power-on operation instruction, and the power-on operation instruction is sent to the lighting equipment 112. Finally, the lighting equipment 112 receives the power-on operation instruction, and performs a power-on operation.

Optionally, multiple intelligent devices of a same type may be disposed in different positions in an environment 100. As shown in FIG. 6(b), the environment 100 includes two lighting equipments 112 and 113. It may be understood that, a quantity of lighting equipments shown in FIG. 6(b) is merely an example. The quantity of lighting equipments may be greater than two. In addition, the environment 100 may further include multiple television devices 111 and/or multiple media player devices 115. The user may use the first gesture action to point to different lighting equipments, so that the different lighting equipments execute the voice instruction.

As shown in FIG. 6(b), a radial is drawn from the location of the dominant eye of the user to the location of the tip of the forefinger of the user, an intersection point between the radial and an object in the space is determined, and the lighting equipment 112 in the two lighting equipments is used as a device for executing the voice instruction “power on”.

In actual use, a first angle-of-view image seen by the user 106 by using a display 331 is shown in FIG. 6(c), and a circle 501 is a position to which the user points. Seen from the user, the tip of the finger points to an intelligent device 116.

The location of the tip of the forefinger in the three-dimensional space, determined by the camera 323, is determined according to a depth image captured by a depth camera and an RGB image captured by an RGB camera jointly.

The depth image captured by the depth camera may be used to determine whether the user has performed an action of raising an arm and/or stretching an arm. For example, when a distance over which the arm is stretched in the depth image exceeds a preset value, it is determined that the user has performed the action of stretching the arm. The preset value may be 10 cm.

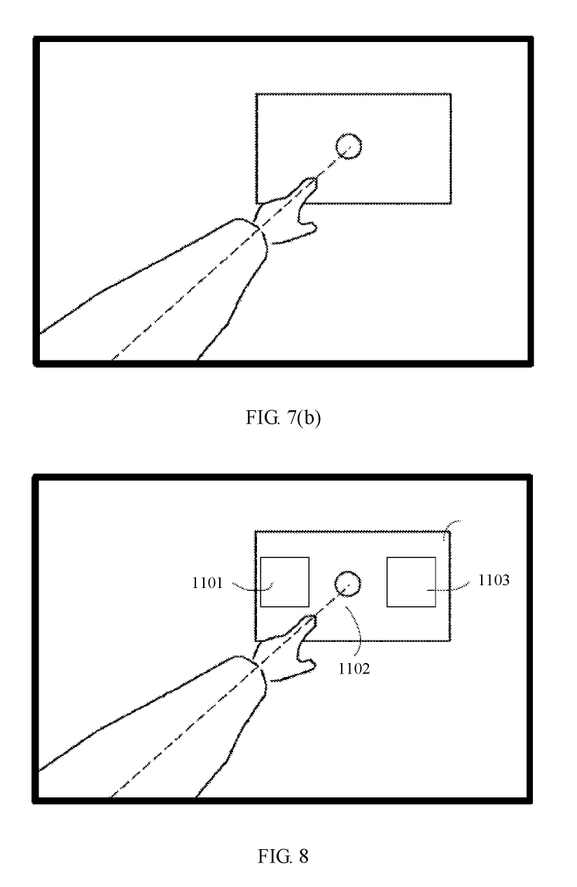

With reference to a second embodiment shown in FIG. 7(a) and FIG. 7(b), the following describes in detail a method for determining an object for executing a voice instruction according to a second gesture action, so as to control an intelligent device.

In the second embodiment, without considering a location of an eye, a direction to which a user points is determined only according to an extension line of an arm and/or a finger, and a second gesture action of the user in the second embodiment is different from the foregoing first gesture action.

Likewise, a processor 340 performs speech recognition processing. When no execution object is specified in a voice instruction, for example, the voice instruction is “power on”, the processor 340 determines, based on a second gesture action of a user 106, an object that is expected by the user 106 to execute the voice instruction “power on”. The second gesture action is a combined action of stretching an arm, stretching out a forefinger to point to a target, and dwelling in a highest position by the arm.

As shown in FIG. 7(a), after the processor 340 detects that the user performs the second gesture action, a television device 111 on an extension line from the arm to the finger is used as a device for executing the voice instruction “power on”.

In actual use, a first angle-of-view image seen by the user 106 by using a display 331 is shown in FIG. 7(b), and a circle 601 is a position to which the user points. The extension line from the arm to the forefinger points to an intelligent device 116.

In the second embodiment, locations of the arm and the finger in three-dimensional space are determined according to a depth image captured by a depth camera and an RGB image captured by an RGB camera jointly.

The depth image captured by the depth camera is used to determine a location of a fitted straight line formed by the arm and the finger in the three-dimensional space. For example, when a dwell time of the arm in a highest position in the depth image exceeds a preset value, the location of the fitted straight line may be determined. The preset value may be 0.5 second.

Stretching the arm in the second gesture action does not require a rear arm and a forearm of the user to be completely on a straight line, provided that the arm and the finger can determine a direction and point to an intelligent device in the direction.

Optionally, the user may also point to a direction by using another gesture action. For example, the rear arm and the forearm form an angle, and the forearm and the finger point to a direction; or when the arm points to a direction, the fingers clench into a fist.

The foregoing describes the process of determining, according to the first or second gesture action, the object for executing the voice instruction. It may be understood that, before the determining process is performed, the foregoing three-dimensional modeling operation, and user profile creating or reading operation need to be implemented first. In the three-dimensional modeling process, an intelligent device in the background scene and/or the physical space is successfully recognized, and in the determining process, an input unit 320 is in a monitoring state. When the user 106 moves, the input unit 320 determines a location of each intelligent device in an environment 100 in real time.

The foregoing describes the process of determining, according to the first or second gesture action, the object for executing the voice instruction. In the determining process, speech recognition processing is performed first, and then gesture action recognition is performed. It may be understood that, speech recognition and gesture recognition may be interchanged. For example, the processor 340 may first detect whether the user has performed the first or second gesture action, and after detecting the first or second gesture action of the user, start the operation of recognizing whether the execution object is specified in the voice instruction. Optionally, speech recognition and gesture recognition may also be performed simultaneously.

The foregoing describes a case in which no execution object is specified in the voice instruction. It may be understood that, when the execution object is specified in the voice instruction, the processor 340 may directly determine the object for executing the voice instruction, or may check, by using the determining methods in the first and second embodiments, whether the execution object recognized by the processor 340 is the same as the intelligent device to which the finger of the user points. For example, when the voice instruction is “display weather forecast on a smart television”, the processor 340 may directly control the television device 111 to display weather forecast, or may detect, by using the input unit 320, whether the user has performed the first or second gesture action, and if the user has performed the first or second gesture action, further determine, based on the first or second gesture action, whether a tip of the forefinger of the user or the extension line of the arm points to the television device 111, so as to verify whether the processor 340 recognizes the voice instruction accurately.

The processor 340 may control a sampling rate of the input unit 320. For example, before the voice instruction is received, a camera 323 and an inertial measurement unit 322 are both in a low sampling rate mode. After the voice instruction is received, the camera 323 and the inertial measurement unit 322 switch to a high sampling rate mode. In this way, power consumption of an HMD 104 may be reduced.

The foregoing describes the process of determining, according to the first or second gesture action, the object for executing the voice instruction. In the determining process, visual experience of the user is enhanced by using an augmented reality or mixed reality technology. For example, when the first or second gesture action is detected, a virtual extension line may be displayed in the three-dimensional space. This helps the user visually see the intelligent device to which the finger points. One end of the virtual extension line is the finger of the user, and the other end is the determined intelligent device for executing the voice instruction. After the processor 340 determines the intelligent device for executing the voice instruction, a pointing line during the determining and an intersection point between the pointing line and the intelligent device may be highlighted. The intersection point may be optionally the foregoing circle 501. A manner of highlighting may be changing a color or thickness of the virtual extension line. For example, at the beginning, the extension line is thin green, and after the determining, the extension line changes into bold red, and there is a dynamic effect of sending out from the tip of the finger. The circle 501 may be magnified and displayed, and after the determining, may be magnified in a circular ring and disappear.

The foregoing describes the method for determining, by using the HMD 104, the object for executing the voice instruction. It may be understood that, another appropriate terminal may be used to perform the determining method. The terminal includes the communications unit, the input unit, the processor, the memory, and the power supply unit described above. The terminal may be in a form of a controlling device. The controlling device may be suspended or placed in an appropriate position in the environment 100. Three-dimensional modeling is performed on the environment through rotation, an action of the user is traced in real time, and voice and gesture actions of the user are detected. Because the user does not need to use a head-mounted device, burden of the eye may be mitigated. The controlling device may determine, by using the first or second gesture action, the object for executing the voice instruction.

With reference to a third embodiment shown in FIG. 8, the following describes in detail a method for performing voice and gesture control on multiple applications in an intelligent device.

In the first and second embodiments, how the processor 340 determines the device for executing the voice instruction is described. On this basis, more operations may be performed on the execution device by using a voice and a gesture. For example, after a television device 111 receives a “power on” command and performs a power-on operation, different applications may be further started according to commands of a user. Specific steps of performing operations on multiple applications in the television device 111 are as follows. The television device 111 optionally includes a first application 1101, a second application 1102, and a third application 1103.

Step 801: Recognize an intelligent device for executing a voice instruction, and obtain parameters of the device, where the parameters include at least whether the device has a display screen, a range of coordinate values of the display screen, and the like, and the range of the coordinate values may further include a location of an origin and a positive direction. Using a television device 111 as an example, parameters of the television device 111 are: the television device has a rectangular display screen, an origin of coordinates is located in a lower left corner, a value range of horizontal coordinates is 0 to 4096, and a value range of vertical coordinates is 0 to 3072.

Step 802: An HMD 104 obtains image information by using a camera 323, determines a location of a display screen of a television device 111 in a field of view 102 of the HMD 104, traces the television device 111 continuously, detects a relative position relationship between a user 106 and the television device 111 in real time, and detects the location of the display screen in the field of view 102 in real time. In this step, a mapping relationship between the field of view 102 and the display screen of the television device 111 is established. For example, a size of the field of view 102 is 5000×5000; coordinates of an upper left corner of the display screen in the field of view 102 are (1500, 2000); and coordinates of a lower right corner of the display screen in the field of view 102 are (3500, 3500). Therefore, for a specified point, when coordinates of the point in the field of view 102 or coordinates of the point on the display screen are known, the coordinates may be converted into coordinates on the display screen or coordinates in the field of view 102. When the display screen is not in a middle position in the field of view 102, or the display screen is not parallel with a view plane of the HMD 104, due to a perspective principle, the display screen is presented as a trapezoid in the field of view 102. In this case, coordinates of four vertices of the trapezoid in the field of view 102 are detected, and a mapping relationship is established with coordinates thereof on the display screen.

Step 803: When detecting that the user performs the foregoing first or second gesture action, a processor 340 obtains coordinates (X2, Y2) of a position to which the user points, namely, the foregoing circle 501, in the field of view 102. According to the mapping relationship established in step 702, coordinates (X1, Y1) of the coordinates (X2, Y2) in a coordinate system of the display screen of the television device 111 are computed, and the coordinates (X1, Y1) are sent to the television device 111, so that the television device 111 determines, according to the coordinates (X1, Y1), an application or an option in an application that will receive the instruction. The television device 111 may also display a specific identifier on the display screen of the television device 111 according to the coordinates. As shown in FIG. 8, the television device 111 determines, according to the coordinate (X1, Y1), that the application that will receive the instruction is a second application 1102.

Step 804: The processor 340 performs speech recognition processing, converts the voice instruction into an operation instruction and sends the operation instruction to the television device 111; after receiving the operation instruction, the television device 111 starts a corresponding application to perform an operation. For example, both a first application 1101 and the second application 1102 are video play software; when the voice instruction sent by the user is “play movie XYZ”, because it is determined, according to the position to which the user points, that the application that will receive the voice instruction “play movie XYZ” is the second application 1102, a movie named “XYZ” and stored in the television device 111 is played by using the second application 1102.

The foregoing describes the method for performing voice and gesture control on multiple applications 1101 to 1103 in the intelligent device. Optionally, the user may also control an operation option in a function interface of an application program. For example, when the movie named “XYZ” is played by using the second application 1102, the user points to a volume control operation option and says “increase” or “enhance”, the HMD 104 parses the pointed-to direction and the speech of the user, and sends an operation instruction to the television device 111; and the second application 1102 of the television device 111 increases the volume.

In the foregoing third embodiment, the method for performing voice and gesture control on multiple applications in the intelligent device is described. Optionally, when the received voice instruction is used for payment, or when the execution object is a payment application such as online banking, Alipay, or Taobao, authorization and authentication may be performed by means of biological feature recognition to improve payment security. An authorization and authentication mode may be detecting whether a biological feature of the user matches a registered biological feature of the user.

For example, the television device 111 determines, according to the coordinates (X1, Y1), that an application that will receive an instruction is a third application 1103, where the third application is an online shopping application; when detecting a voice instruction “start”, the television device 111 starts the third application 1103. The HMD 104 continuously traces an arm of the user and a direction to which a finger of the user points. When the HMD 104 detects that the user points to an icon of a commodity in an interface of the third application 1103 and sends a voice instruction “purchase this”, the HMD 104 sends an instruction to the television device 111. The television device 111 determines that the commodity is a purchase object, and prompts, by using a graphical user interface, the user to confirm purchase information and make payment. After the HMD 104 recognizes input voice information of the user, sends the input voice information to the television device 111, converts the input voice information into a text, and fills in purchase information, the television device 111 performs a payment step and sends an authentication request to the HMD 104. After receiving the authentication request, the HMD 104 may prompt the user of an identity authentication method. For example, iris authentication, voice print authentication, or fingerprint authentication may be selected, or at least one of the foregoing authentication methods may be used by default. An authentication result is obtained after the authentication is complete. The HMD 104 encrypts the identity authentication result and sends it to the television device 111. The television device 111 completes a payment action according to the received authentication result.

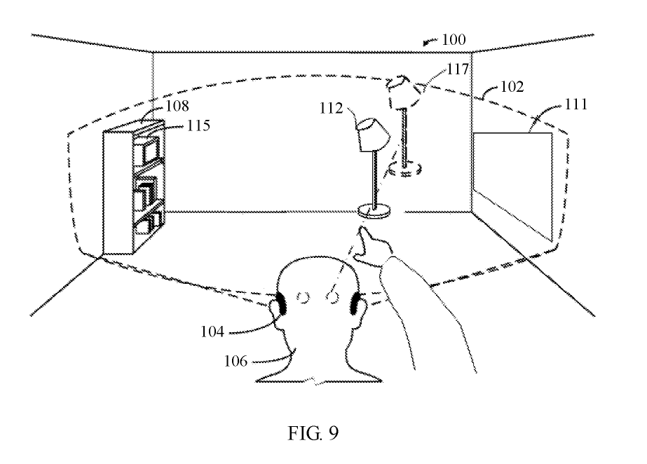

With reference to a fourth embodiment shown in FIG. 9, the following describes in detail a method for performing voice and gesture control on multiple intelligent devices on a same straight line.

The foregoing describes the process of determining, according to the first or second gesture action, the object for executing the voice instruction. In some cases, multiple intelligent devices exist in the space. In this case, a radial is drawn from the first reference point to the second reference point, and the radial intersects the multiple intelligent devices in the space. When determining is performed according to the second gesture action, the extension line determined by the arm and the forefinger also intersects the multiple intelligent devices in the space. To precisely determine which intelligent device on a same straight line is expected by the user to execute a voice instruction, a more precise gesture is required for distinguishing.

As shown in FIG. 9, lighting equipment 112 exists in a living room shown in an environment 100, and second lighting equipment 117 exists in a room adjacent to the living room. Seen from a current location of a user 106, the first lighting equipment 112 and the second lighting equipment 117 are located on a same straight line. When the user performs a first gesture action, a radial drawn from a dominant eye of the user to a tip of a forefinger intersects the first lighting equipment 112 and the second lighting equipment 117 in sequence. The user may distinguish multiple devices on a same straight line by refining gestures. For example, the user may stretch out a finger to indicate that the first lighting equipment 112 will be selected, and stretch out two fingers to indicate that the second lighting equipment 117 will be selected, and so on.

In addition to using different quantities of fingers to indicate which device is selected, a method of bending a finger or an arm may be used to indicate that a specific device is bypassed, and raising the finger every time means skipping to a next device on an extension line. For example, the user may bend the forefinger to indicate that the second lighting equipment 117 on the straight line is selected.

In a specific application, after a processor 340 detects that the user performs the foregoing first or second gesture action, whether multiple intelligent devices exist in a direction to which the user points is determined according to a three-dimensional modeling result. If a quantity of intelligent devices in the pointed-to direction is greater than 1, a prompt is given in a user interface, prompting the user to confirm which intelligent device is selected.

There are multiple solutions to giving a prompt in the user interface. For example, a prompt is given on a display of a head-mounted display device by using an augmented reality or mixed reality technology, all intelligent devices in the direction to which the user points are displayed, and one of the devices is used as a target currently selected by the user. The user may make a selection by sending a voice instruction, or make a further selection by performing an additional gesture. The additional gesture may optionally include the foregoing different quantities of fingers or bending a finger, and a like.

It may be understood that, although the second lighting equipment 117 and the first lighting equipment 112 in FIG. 9 are located in different rooms, the method shown in FIG. 9 may also be used to distinguish different intelligent devices in a same room.

In the foregoing embodiment, an action of pointing to a direction by using the forefinger is described. However, the user may also point to a direction by using another finger according to a habit of the user. The use of the forefinger is merely an example for description, and does not constitute a specific limitation on the gesture action.

Method steps described in combination with the content disclosed in the present invention may be implemented by hardware, or may be implemented by a processor by executing a software instruction. The software instruction may be formed by a corresponding software module. The software module may be located in a RAM memory, a flash memory, a ROM memory, an EPROM memory, an EEPROM memory, a register, a hard disk, a removable magnetic disk, a CD-ROM, or a storage medium of any other form known in the art. For example, a storage medium is coupled to a processor, so that the processor can read information from the storage medium or write information into the storage medium. Certainly, the storage medium may be a component of the processor. The processor and the storage medium may be located in the ASIC. In addition, the ASIC may be located in user equipment. Certainly, the processor and the storage medium may exist in the user equipment as discrete components.

A person skilled in the art should be aware that in the foregoing one or more examples, functions described in the present invention may be implemented by hardware, software, firmware, or any combination thereof. When the present invention is implemented by software, the foregoing functions may be stored in a computer-readable medium or transmitted as one or more instructions or code in the computer-readable medium. The computer-readable medium includes a computer storage medium and a communications medium, where the communications medium includes any medium that enables a computer program to be transmitted from one place to another. The storage medium may be any available medium accessible to a general-purpose or dedicated computer.

The objectives, technical solutions, and benefits of the present invention are further described in detail in the foregoing specific embodiments. It should be understood that the foregoing descriptions are merely specific embodiments of the present invention, but are not intended to limit the protection scope of the present invention. Any modification, equivalent replacement, or improvement made within the spirit and principle of the present invention shall fall within the protection scope of the present invention.

What is claimed is:

1. A method, applied to a terminal, wherein the method comprises:
receiving a voice instruction that does not specify an execution object;
recognizing a gesture action of a user, and determining, according to the gesture action, a target to which the user points, wherein the target comprises an electronic device, an application program installed on an electronic device, or an operation option in a function interface of an application program installed on an electronic device;
converting the voice instruction into an operation instruction; and
sending the operation instruction to the electronic device.

2. The method according to claim 1, further comprising:
receiving another voice instruction that specifies an execution object;
converting the another voice instruction into another operation instruction; and
sending the another operation instruction to the execution object.

3. The method according to claim 1, wherein the recognizing a gesture action of the user, and determining, according to the gesture action, a target to which the user points comprises:
recognizing an action of stretching out a finger by the user,
obtaining a location of a dominant eye of the user in three-dimensional space and a location of a tip of the finger in the three-dimensional space, and
determining a target to which a straight line connecting the dominant eye to the tip points in the three-dimensional space.

4. The method according to claim 1, wherein the recognizing a gesture action of the user, and determining, according to the gesture action, a target to which the user points comprises:
recognizing an action of raising an arm by the user, and
determining a target to which an extension line of the arm points in three-dimensional space.

5. The method according to claim 3, wherein the straight line points to at least one electronic device in the three-dimensional space, and the determining a target to which a straight line connecting the dominant eye to the tip points in the three-dimensional space comprises: prompting the user to select one of the at least one electronic device.

6. The method according to claim 4, wherein the extension line points to at least one electronic device in the three-dimensional space, and the determining a target to which an extension line of the arm points in the three-dimensional space comprises: prompting the user to select one of the at least one electronic device.

7. The method according to claim 1, wherein the terminal is a head-mounted display device, and the target to which the user points is highlighted in the head-mounted display device.

8. The method according to claim 1, wherein the voice instruction is used for payment, and the method further comprises: before the sending the operation instruction to the electronic device, detecting whether a biological feature of the user matches a registered biological feature of the user.

9-19. (canceled)

20. A terminal, comprising:
a memory comprising instructions; and
a processor coupled to the memory, the instructions being executed by the processor to cause the terminal to be configured to:
receive a voice instruction that does not specify an execution object;
recognize a gesture action of a user;
determine, according to the gesture action, a target to which the user points, wherein the target comprises an electronic device, an application program installed on an electronic device, or an operation option in a function interface of an application program installed on an electronic device;
convert the voice instruction into an operation instruction; and
send the operation instruction to the electronic device.

21. The terminal of claim 20, wherein the instructions further cause the terminal to:
receive another voice instruction that specifies an execution object;
convert the another voice instruction into another operation instruction; and
send the another operation instruction to the execution object.

22. The terminal of claim 20, wherein the instructions further cause the terminal to:
recognize an action of stretching out a finger by the user;
obtain a location of a dominant eye of the user in three-dimensional space and a location of a tip of the finger in the three-dimensional space; and
determine a target to which a straight line connecting the dominant eye to the tip points in the three-dimensional space.

23. The terminal of claim 22, wherein the straight line points to at least one electronic device in the three-dimensional space, and the instructions further cause the terminal to:
prompt the user to select one of the at least one electronic device.

24. The terminal of claim 20, wherein the instructions further cause the terminal to:
recognize an action of raising an arm by the user; and
determine a target to which an extension line of the arm points in the three-dimensional space.

25. The terminal of claim 24, wherein the extension line points to at least one electronic device in the three-dimensional space, and the instructions further cause the terminal to:
prompt the user to select one of the at least one electronic device.

26. The terminal of claim 20, wherein the terminal is a head-mounted display device, and the target to which the user points is highlighted in the head-mounted display device.

27. The terminal of claim 20, wherein the voice instruction is used for payment, and the instructions further cause the terminal to:
detect whether a biological feature of the user matches a registered biological feature of the user.
